(19) United States
(12) Patent Application Publication
(10) Pub. No.: US 2024/0117800 A1
(43) Pub. Date: Apr. 11, 2024

(54) PISTON FOR A PISTON PUMP, METHOD FOR PRODUCING A PISTON, AND PISTON PUMP

(71) Applicants: thyssenkrupp Dynamic Components GmbH, Ilsenburg (Harz) (DE); thyssenkrupp AG, Essen (DE)

(72) Inventors: Uwe DIETEL, Lichtentanne (DE); Sebastian PIETSCHKER, Chemnitz (DE)

(73) Assignees: thyssenkrupp Dynamic Components GmbH, Ilsenburg (Harz) (DE); thyssenkrupp AG, Essen (DE)

(21) Appl. No.: 18/275,946

(22) PCT Filed: Feb. 2, 2022
(86) PCT No.: PCT/EP2022/052512

§ 371 Date: Aug. 4, 2023

(30) Foreign Application Priority Data
Feb. 5, 2021 (DE) 10 2021 201 112.8

(51) Int. Cl. F04B 39/00; F16J 1/00

(52) U.S. Cl. CPC F04B 39/0016; F16J 1/005

(57) ABSTRACT

The present disclosure relates to a piston for a piston pump, in particular a piston compressor, including a piston main body and a piston crown valve that includes a lamellar valve plate. The lamellar valve plate is fastened to the piston main body by a collar ring.

The present invention relates to a piston for a piston pump, in particular piston compressor, according to the preamble of claim 1, and to a method for producing a piston, according to the preamble of claim 8. The invention furthermore relates to a piston pump, in particular piston compressor, according to the preamble of claim 11.

The prior art has disclosed pistons having piston crown valves for piston compressors and vacuum pumps. DE 103 223 52 A1 describes an axial refrigerant compressor which has a hollow cylindrical piston which has an intake valve at the end side averted from the swash plate. DE 199 17 009 A1 describes a vacuum pump, for example.

Although pistons suitable for piston pumps are known from the prior art, there is still a demand for improvement with regard to the assembly and production of such pistons.

The present invention addresses this, and it is the object of the invention to propose an improved piston, in particular to propose a piston which is distinguished by the fact that a piston crown valve can be easily installed on the piston crown.

According to the invention, said object is achieved by a piston having the characterizing features of claim 1. Simple assembly can be ensured by virtue of the fact that the lamellar valve plate is fastened to the piston main body by means of a collar ring. The installation of the piston crown valve is made possible in particular by the fact that the top land of the piston is designed as a collar ring that is pushed over a set-back diameter on the piston. The plate valve is in particular placed onto the piston crown and fixed by virtue of the collar ring being pressed on, wherein an inwardly stepped collar situated on the ring presses against the plate and in particular, by way of its inside diameter, simultaneously centers said plate on the piston.

Further advantageous refinements of the proposed invention are apparent in particular from the features of the subclaims. The subjects or features of the various claims may in principle be combined with one another as desired.

In one advantageous refinement of the invention, provision may be made for the piston main body to have, in an axial direction proceeding from the piston crown, a first portion with an outside diameter and at least one second portion with an outside diameter, wherein the outside diameter of the first portion is smaller than the outside diameter of the second portion. By means of this measure, the piston main body can be configured to receive the collar ring. The collar ring is in particular pressed onto the first portion.

In a further advantageous refinement of the invention, provision may be made for the collar ring to be of hollow cylindrical form, wherein the collar ring has, in an axial direction, at least one first portion with an inside diameter and one second portion with an inside diameter, wherein the inside diameter of the second portion is smaller than the inside diameter of the first portion and in particular forms an encircling collar or projection. The collar within the collar ring can be formed by means of this measure.

In a further advantageous refinement of the invention, provision may be made for the inside diameter of the first portion of the collar ring to correspond to the outside diameter of the first portion of the piston main body such that the piston main body and the collar ring form an interference fit. By adjusting the relationship between inside and outside diameter, the tightness of the interference fit can be increased or decreased.

In a further advantageous refinement of the invention, provision may be made for the lamellar plate valve to comprise an outer ring with an outside diameter and to comprise a valve disk, wherein a spring element is provided between the outer ring and the valve disk. Such a lamellar valve plate valve is advantageously suitable for closing and opening up a central opening in the piston crown.

In a further advantageous refinement of the invention, provision may be made for the lamellar valve plate, in particular the outer ring, to be received at least in part between the piston crown and the collar ring, in particular between the first portion of the piston main body and the second portion of the collar ring. An axial displacement and in particular also a radial displacement of the lamellar valve plate are thus no longer possible.

In a further advantageous refinement of the invention, provision may be made whereby the first portion of the piston main body is configured to be longer, by at least the extent of the height of the piston ring, than the collar ring. This means that, after the collar ring has been pushed on, in particular so as to form a block with/abut against the lamellar valve plate and indirectly the piston crown, there is a partial region of the first portion of the piston main body that is not surrounded by the collar ring. A piston ring receptacle, in particular piston ring groove, is thus formed, in which the piston ring can be received. An advantageous means for forming a piston ring receptacle can thus be created.

In a further advantageous refinement of the invention, provision may be made whereby the collar ring and the piston main body between them form a receptacle for a piston ring, in particular whereby a piston ring receptacle for a piston ring is formed between a shoulder, which results from the transition between the second portion and the first portion of the piston main body, and the free end of the first portion of the collar ring, wherein a piston ring is received in the piston ring receptacle.

By means of this design, the piston ring can particularly advantageously be installed when in the closed state. The severing of the piston ring can thus be dispensed with, and the piston ring in particular has no joints. A working step during the production of the ring, in particular the severing of the ring, can be omitted. The ring is more dimensionally stable, and possible leakage at the ring gap is eliminated.

It is a further object of the present invention to propose an improved method for producing a piston for a piston pump, in particular to propose a method for producing a piston for a piston pump by which such a piston can be produced easily.

According to the invention, said object is achieved by a method having the characterizing features of claim 8. By virtue of the fact that the production method comprises at least the method steps:
placing the lamellar valve plate onto the piston crown and pushing, in particular pressing, the collar ring onto the piston main body,
the proposed invention describes a technically easily implementable, inexpensive solution for installing a lamellar valve plate on a piston for a piston pump. It is self-evidently not ruled out that the production method has further steps or intermediate steps that are known to a person skilled in the art.

Further advantageous refinements of the proposed invention are apparent in particular from the features of the subclaims. The subjects or features of the various claims may in principle be combined with one another as desired.

In one advantageous refinement of the invention, provision may be made whereby, before the collar ring is pushed, in particular pressed, onto the piston main body, a piston ring is threaded onto the piston main body, in particular onto the first portion of the piston main body, and placed onto a shoulder that is formed owing to the difference in diameter between the first and second portions of the piston main body. A technically easily implementable, inexpensive solution for installing a piston ring on a piston for a piston pump is thus described.

It is a further object of the invention to propose an improved piston pump, in particular to propose a piston pump which is distinguished by the fact that it is easy to assemble.

According to the invention, said object is achieved by a piston pump having the characterizing features of claim 11. Through the use of a piston according to the invention, the assembly advantages can be made applicable to the piston pump.

Further features and advantages of the present invention will become clear from the following description of preferred exemplary embodiments with reference to the appended figures, in which:

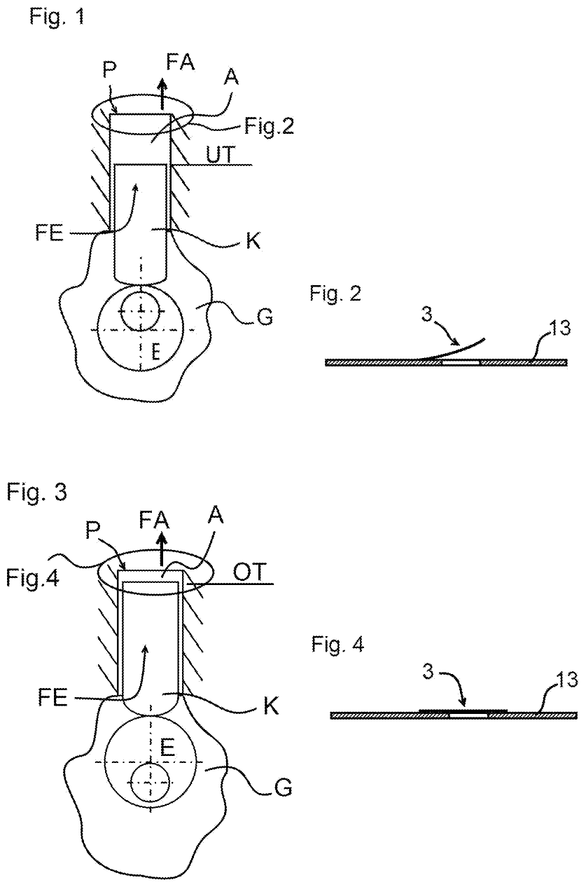

FIG. 1 is a schematic illustration of a piston pump (piston at UT);

FIG. 2 shows a detail “X” as per FIG. 1;

FIG. 3 is a schematic illustration of a piston pump (piston at OT);

FIG. 4 shows a detail “Y” as per FIG. 3;

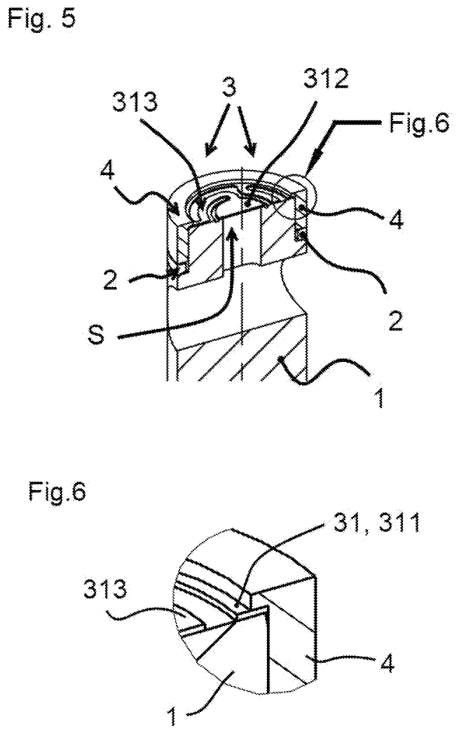

FIG. 5 shows a piston according to the invention in a perspective illustration;

FIG. 6 shows a detail “Z” as per FIG. 5;

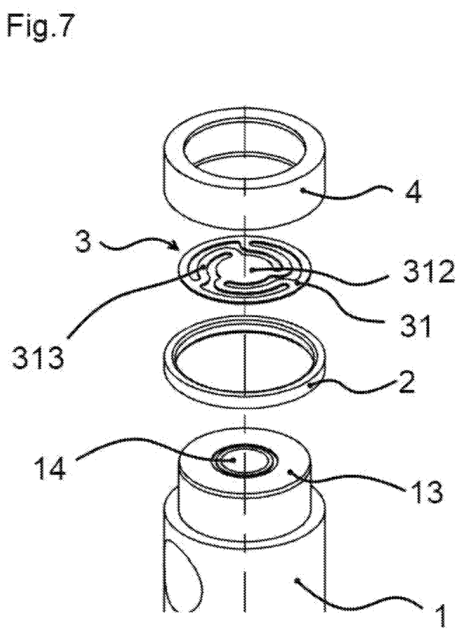

FIG. 7 is an exploded illustration of a piston according to the invention;

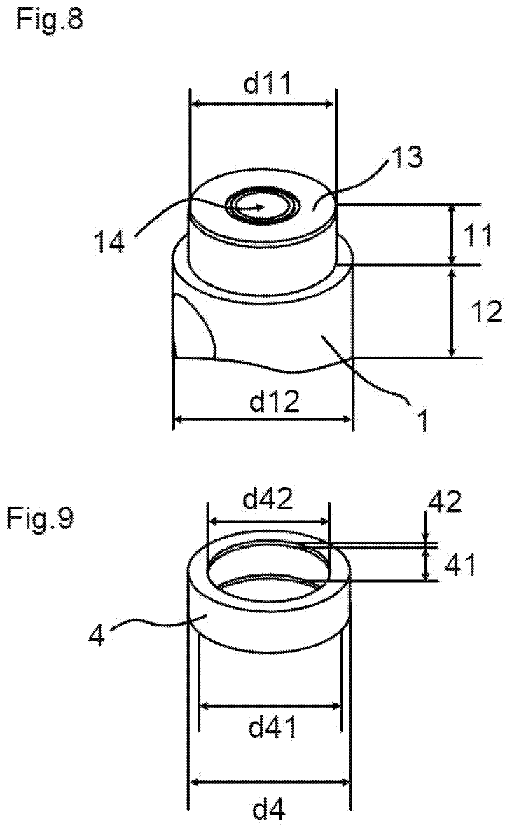

FIG. 8 shows a piston main body for a piston according to the invention;

FIG. 9 shows a collar ring for a piston according to the invention;

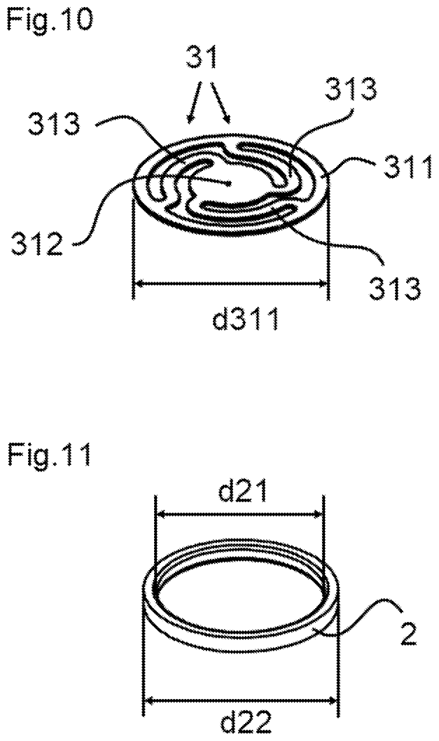

FIG. 10 shows a lamellar valve plate for a piston according to the invention;

FIG. 11 shows a piston ring for a piston according to the invention.

The following reference designations are used in the figures:
K Piston
A Working chamber
P Cylinder head
FE Fluid inlet
FA Fluid outlet
G Crankcase
E Crankshaft/eccentric shaft
UT Bottom dead center
OT Top dead center
S Flow direction of fluid
d4 Outside diameter of the collar ring
d11 Outside diameter of first portion of the piston main body
d12 Outside diameter of second portion of the piston main body
d21 Inside diameter of the piston ring
d22 Outside diameter of the piston ring
d41 Inside diameter of first portion of the collar ring
d42 Inside diameter of second portion of the collar ring
d311 Outside diameter of the outer ring of the lamellar valve plate
1 Piston main body
2 Piston ring
3 Piston crown valve
4 Collar ring
11 First portion
12 Second portion
13 Piston crown
14 Valve opening
31 Lamellar valve plate
41 First portion
42 Second portion
311 Outer ring
312 Valve disk
313 Spring element

Reference is firstly made to FIGS. 1 to 4.

FIGS. 1 to 4 schematically illustrate a piston pump, in particular the schematically indicated interaction of piston, or piston main body, and piston crown valve.

A piston K for a piston pump, in particular a piston compressor, substantially comprises a piston main body 1 and a piston crown valve 3.

A piston pump substantially comprises a working chamber A with the piston K and with a cylinder head P, and also a fluid inlet FE and a fluid outlet FA. The piston is equipped with at least one piston crown valve 3. In general, the piston is driven in the working chamber by means of a crankshaft E or an eccentric. Here, the crankcase G generally forms the fluid inlet FE, and the fluid outlet FA is arranged in the cylinder head P. The piston crown valve 3 correspondingly opens when the piston K is moving toward the crankcase K, that is to say in the direction of UT (bottom dead center), and closes when said piston is moving toward the cylinder head P, that is to say in the direction of OT (top dead center). The fluid is conveyed from the fluid inlet FE to the fluid outlet FA. Accordingly, it is possible in particular for flow to pass through the piston K in order that fluid passes from a low-pressure side into the working chamber and from there, via the fluid outlet, to a high-pressure side.

Reference will hereinafter be made to FIGS. 5 to 11.

The piston crown valve 3 substantially comprises a preferably central valve opening 14 in the piston crown 13, and a lamellar valve plate 31. The piston crown valve 3 is preferably designed as a centrally opening lamellar valve, or reed valve, which is fixed at the outside. Other forms of lamellar valves or reed valves are however also possible in principle, in particular valves which run at least partially in a circumferential direction or radially, with multiple valve openings, etc. All of these share the fact that they are fixed at the outside in a circular ring-shaped region.

According to the invention, provision is made for the lamellar valve plate 31 to be fastened to the piston main body 1 by means of a collar ring 4.

The piston main body 1 has a first portion 11 and at least one second portion 12 in an axial direction proceeding from the piston crown 13. The first portion 11, which is closest to the piston crown 13, has an outside diameter d11, and the second portion 12, which is further remote from the piston crown 13, has an outside diameter d12. The outside diameter d11 of the first portion 11 is smaller than the outside diameter d12 of the second portion 12. The first portion 11 can also be referred to as a set-back diameter on the piston main body 1.

The collar ring 4 is substantially a hollow cylindrical body, in particular with a circular cross section. On the inside, the collar ring 4 has at least two portions, in particular a first portion 41 and a second portion 42, in an axial direction. The first portion 41 has an inside diameter d41, and the second portion 42 has an inside diameter d42. The inside diameter d42 of the second portion 42 is smaller than the inside diameter d41 of the first portion 41. The second portion 42 can also be referred to as an encircling collar or projection. The first portion 41 corresponds in terms of its inside diameter d41 to the outside diameter d11 of the first portion 11 of the piston main body 1, in particular such that the piston main body 1 and collar ring 4 form an interference fit when connected.

The lamellar valve plate 31 preferably comprises an outer ring 311 and a valve disk 312. A spring element 313 is preferably provided between the outer ring 311 and the valve disk 312. The lamellar valve plate may preferably be formed as a punched sheet-metal part. The spring element 313 is, or the spring elements are, formed for example as sheet-metal strips which run, in part, in a circumferential direction. The outer ring 311 has an outside diameter d311.

Further details of the invention are apparent in particular from a process of assembling the piston with the aid of the collar ring arrangement 4.

The lamellar valve plate 31 is placed onto the piston crown 13. The outside diameter of the lamellar valve plate 31, in particular the outside diameter d311 of the outer ring 311 of the lamellar valve plate 31, preferably corresponds to the outside diameter d11 of the first portion 11 of the piston main body 1, such that the lamellar valve plate 31 and the first portion 11 are aligned.

The collar ring 4, in particular the first portion 41, is subsequently pushed, in particular pressed, onto the first portion 11 of the piston main body 1. As a result, the lamellar valve plate 31, in particular the outer ring 311, is received at least in part between the piston crown 13 and the collar ring 4, in particular between the first portion 11 of the piston main body 1 and the second portion 42 of the collar ring 4, such that the lamellar valve plate 31 is fixed, in particular in an axial direction. The lamellar valve plate is preferably also fixed or centered in a radial direction by the collar ring 4. In this context, provision may be made for the outside diameter of the lamellar valve plate 31, in particular the outside diameter d311 of the outer ring 311 of the lamellar valve plate 31, to be equal to the inside diameter d41 of the first portion 41.

Provision may furthermore be made for the collar ring 4 to have an outside diameter d4 which corresponds to the outside diameter d12 of the second portion 12 of the piston main body 1. Thus, in particular, the collar ring 4 and piston main body 1 complement one another to form a piston.

Provision may furthermore be made for the piston to be equipped with a piston ring 2. The piston ring 2 is preferably also fixed by means of the collar ring 4.

Provision may preferably furthermore be made for the first portion 11 of the piston main body 1 to be configured to be longer, by at least the extent of the height of the piston ring 2, than the collar ring 4.

The piston ring 2 has an inside diameter d21, wherein the inside diameter d21 should preferably be greater than the outside diameter d11 of the first portion of the piston main body, such that the piston ring 2 can be threaded onto the first portion 11 of the piston. The inside diameter d21 should preferably have a clearance with respect to the first portion 11 of the piston main body 1. The outside diameter d22 of the piston ring 2 is substantially predefined by the cylinder/cylinder diameter of the working chamber A.

Provision may be made for the collar ring 4 to guide or fix the piston ring at the free end of the second portion 42. For the installation of the piston ring 2, the latter may for example have been threaded onto the piston main body 1, and in particular placed onto the shoulder which results from the transition between the second portion 12 and the first portion 11, before the collar ring 4 is pushed on. As a result of the collar ring 4 being pushed on, the piston ring 2 is axially fixed or guided between the shoulder of the second portion 12 and the collar ring 4.

The piston main body 1, in particular the shoulder of the second portion 12, and the collar ring 4, in particular the free end of the first portion 41, preferably form a piston ring receptacle, in particular piston ring groove. An assembly process can be seen in particular in FIG. 7. In particular, the piston main body 1 is held, the piston ring 2 is subsequently threaded on, the piston crown valve 3 is subsequently placed onto the piston crown 13, and the collar ring 4 is subsequently guided over portion 11 of 1 and fixed by way of the interference-fit connection.

The stated diameter relationships are subject to technically necessary tolerances or deviations.

A preferred field of use of the piston pump, in particular piston compressor, is in the field of refrigerant compressors, in particular electric-motor-driven piston pumps or piston compressors, in particular refrigerant compressors.

Features and details described in conjunction with a method self-evidently also apply in conjunction with the device according to the invention and vice versa, such that mutual reference is always or can always be made in respect of the disclosure relating to the individual aspects of the invention. Furthermore, any described method according to the invention can be carried out by means of the device according to the invention.

1-11. (canceled)

12. A piston for a piston pump, comprising:
a piston main body including a piston crown; and
a piston crown valve comprising a lamellar valve plate, wherein the lamellar valve plate is fastened to the piston main body by means of a collar ring.

13. The piston of claim 12, wherein the piston main body has, in an axial direction proceeding from the piston crown, a first portion with an outside diameter (d11) and at least one second portion with an outside diameter (d12), wherein the outside diameter (d11) of the first portion is smaller than the outside diameter (d12) of the second portion.

14. The piston of claim 12, wherein the collar ring is of hollow cylindrical form, wherein the collar ring has, in an axial direction, at least one first portion with an inside diameter (d41) and one second portion with an inside diameter (d42), wherein the inside diameter (d42) of the second portion is smaller than the inside diameter (d41) of the first portion and in particular forms an encircling collar or projection.

15. The piston of claim 12, wherein the inside diameter (d41) of the first portion of the collar ring corresponds to the outside diameter (d11) of the first portion of the piston main body such that the piston main body and the collar ring form an interference fit.

16. The piston of claim 12, wherein the lamellar valve plate comprises an outer ring with an outside diameter (d311) and comprises a valve disk, wherein a spring element is provided between the outer ring and the valve disk.

17. The piston of claim 12, wherein the lamellar valve plate, in particular the outer ring, is received at least in part between the piston crown and the collar ring, in particular between the first portion of the piston main body and the second portion of the collar ring.

18. The piston of claim 12, wherein the first portion of the piston main body is configured to be longer, by at least the extent of the height of the piston ring, than the collar ring.

19. The piston of claim 12, wherein the collar ring and the piston main body between them form a receptacle for a piston ring, in particular in that a piston ring receptacle for a piston ring is formed between a shoulder, which results from the transition between the second portion and the first portion of the piston main body, and the free end of the first portion of the collar ring, wherein a piston ring is received in the piston ring receptacle.

20. A method for producing a piston comprising:
placing a lamellar valve plate onto a piston crown; and
pushing a collar ring onto piston main body.

21. The method of claim 20 wherein, before the collar ring is pushed, in particular pressed, onto the piston main body, a piston ring is placed on the piston main body, in particular on a shoulder which results from the transition between the second portion and the first portion of the piston main body.

22. A piston pump comprising:
a piston including:
a piston main body including a piston crown; and
a piston crown valve comprising a lamellar valve plate, wherein the lamellar valve plate is fastened to the piston main body by means of a collar ring.
